(19) United States
(12) Patent Application Publication
(10) Pub. No.: US 2016/0236459 A1
(43) Pub. Date: Aug. 18, 2016

(54) FIXTURE FOR STATION-TRANSFERRING WHEEL PRINTING

(71) Applicant: CITIC Dicastal CO., LTD, Qinhuangdao (CN)

(72) Inventors: Bowen XUE, Qinhuangdao (CN); Guangcai CHEN, Qinhuangdao (CN); Jiandong GUO, Qinhuangdao (CN); Yongning WANG, Qinhuangdao (CN); Zhihua ZHU, Qinhuangdao (CN); Changhai LI, Qinhuangdao (CN)

(21) Appl. No.: 15/043,077

(22) Filed: Feb. 12, 2016

(30) Foreign Application Priority Data
Feb. 16, 2015 (CN) 201510086268.6

(51) Int. Cl. B41F 3/54

(52) U.S. Cl. CPC B41F 3/54

(57) ABSTRACT

The present invention relates to a fixture for station-transferring wheel printing, which is composed of stands, servo motors, rotating plates, slide sleeves, air cylinders and the like. When in use, the fixture provided by the present invention can meet the requirement for quickly printing a pattern on a fixed window of a wheel and improve the production efficiency effectively, and meanwhile has the characteristics of simple mechanism, high automation degree, advanced technology, safe and stable performance.

### FIELD OF THE INVENTION

The present invention relates to a fixture, and in particular to a fixture for station-transferring wheel printing.

### BACKGROUND OF THE INVENTION

With the continuous improvement of the technology for manufacturing aluminum alloy wheels, customers put forward higher demands on the appearance effect constantly. One is to print a LOGO pattern on the front face of the wheel. As the wheel windows are large in quantity and show no difference, a traditional printing method is that a worker places the wheels on the fixing fixture one by one and then adjusts the angle for printing. This method is not only extremely low in efficiency, but also very inconvenient for operation. The present invention throughly solves the above problem and realizes the automatic turnover of the wheel, with loading/unloading occupying no tact time in production.

### SUMMARY OF THE INVENTION

An object of the present invention is to provide a fixture for station-transferring wheel printing, which can meet the requirement for quickly printing a pattern on a fixed window of a wheel.

In order to achieve the object described above, a technical solution of the present invention is as follows: a fixture for station-transferring wheel printing is composed of a stand, a servo motor, a platform, a bearing seat, a shaft, a rotating plate, a guide rail, a slide block, an air cylinder, a connecting rod, a press head, a turning plate, a pad printing head, a positioning flange, a floating column, a slide sleeve, a spring and a positioning block. The platform above which the bearing seat is mounted is fixed above the stand; the shaft above which the rotating plate is mounted is fixed inside the bearing seat through the bearing; and an output end of the servo motor fixed below the platform is connected with the shaft.

The slide block is fixed above the rotating plate through the guide rail; the turning plate above which the positioning block and the press head are fixed is hinged with the rotating plate; two ends of the connecting rod are respectively hinged with a downside of the turning plate and the slide block; an output end of the air cylinder fixed above the rotating plate is connected with the slide block; the slide sleeve is fixed above the turning plate, and the floating column above which the positioning flange is fixed is matched with the slide sleeve; the spring is fixed below the floating column; a station of the fixture comprises the items described above, and the fixture is composed of 2 or 4 stations.

During actual use, a wheel is placed on the positioning flange at one of the stations and is pressed down, the spring is compressed, and when coming into contact with the positioning block, a lower edge of the wheel is tightly pressed and fixed with the press head; the servo motor drives the rotating plate, the wheel and the like to rotate by 90 degrees or 180 degrees through the shaft; when the wheel is transferred to a position below the pad printing head, the air cylinder drives the slide block to move rightwards through the guide rail; the turning plate and the wheel are rotated by a certain degree under the action of the connecting rod; at the moment, the pad printing head moves downwards to print a fixed pattern onto a front face of the wheel.

When in use, the fixture provided by the present invention can meet the requirement for quickly printing a pattern on a fixed window of a wheel and improve the production efficiency effectively, and meanwhile has the characteristics of simple mechanism, high automation degree, advanced technology, safe and stable performance.

### BRIEF DESCRIPTION OF THE DRAWINGS

FIG. 1 is a front view of a fixture for station-transferring wheel printing.

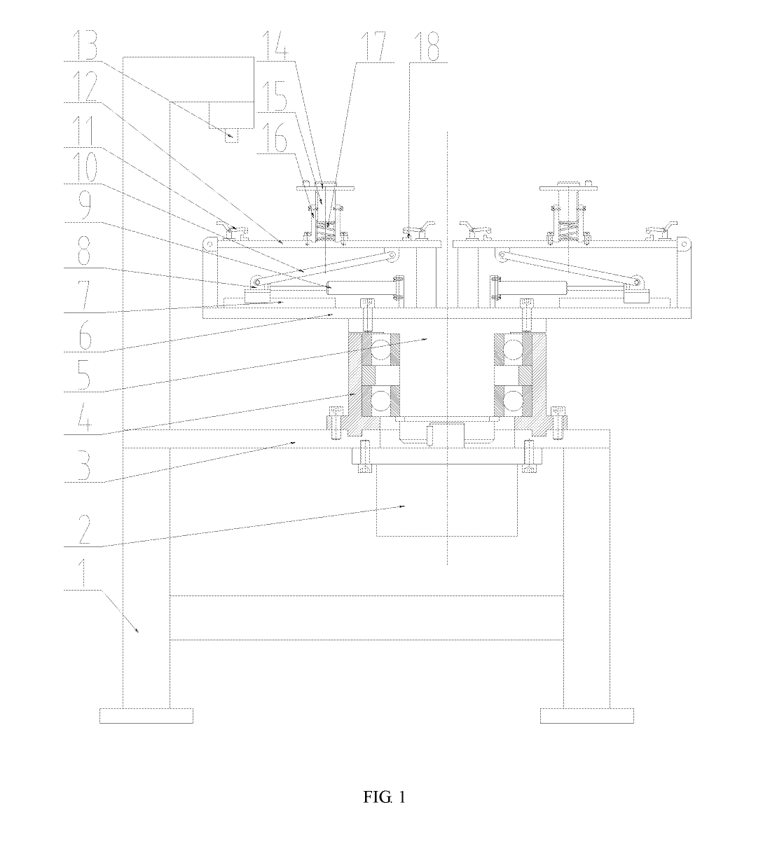

FIG. 2 is a left view of a fixture for station-transferring wheel printing.

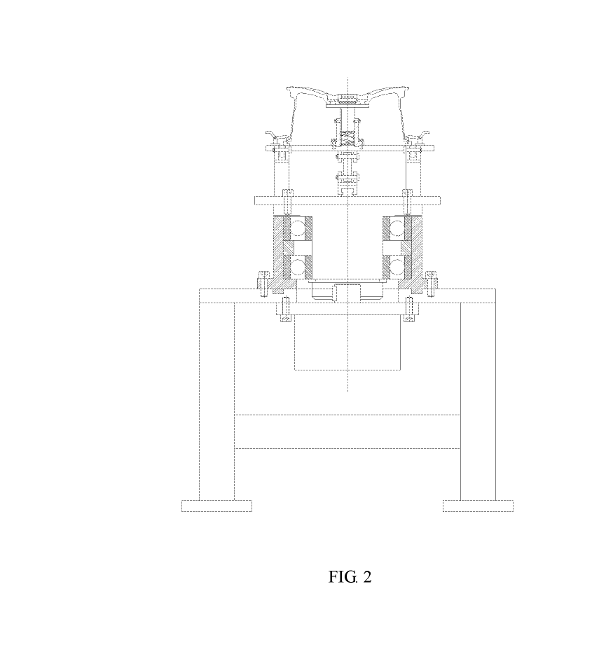

FIG. 3 is a front view of a fixture for station-transferring wheel printing during working.

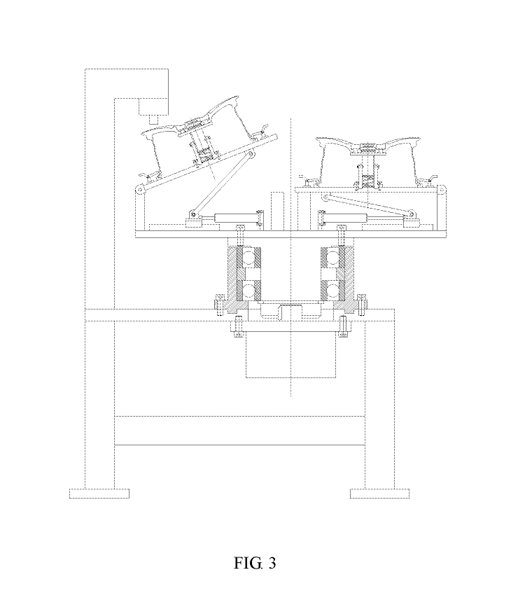

In the drawings, the numeric symbols are as follows: 1—stand, 2—servo motor, 3—platform, 4—bearing seat, 5—shaft, 6—rotating plate, 7—guide rail, 8—slide block, 9—air cylinder, 10—connecting rod, 11—press head, 12—turning plate, 13—pad printing head, 14—positioning flange, 15—floating column, 16—slide sleeve, 17—spring and 18—positioning block.

### DETAILED DESCRIPTION OF THE INVENTION

In the following, the details and working conditions of a specific device provided by the present invention are described in combination with the figures.

The fixture is composed of a stand 1, a servo motor 2, a platform 3, a bearing seat 4, a shaft 5, a rotating plate 6, a guide rail 7, a slide block 8, an air cylinder 9, a connecting rod 10, a press head 11, a turning plate 12, a pad printing head 13, a positioning flange 14, a floating column 15, a slide sleeve 16, a spring 17 and a positioning block 18. The platform 3 above which the bearing seat 4 is mounted is fixed above the stand 1; the shaft 5 above which the rotating plate 6 is mounted is fixed inside the bearing seat 4 through the bearing; an output end of the servo motor 2 fixed below the platform 3 is connected with the shaft 5.

The slide block 8 is fixed above the rotating plate 6 through the guide rail 7; the turning plate 12 above which the positioning block 18 and the press head 11 are fixed is hinged with the rotating plate 6; two ends of the connecting rod 10 are respectively hinged with a downside of the turning plate 12 and the slide block 8; an output end of the air cylinder 9 fixed on the rotating plate 6 is connected with the slide block 8; the slide sleeve 16 is fixed above the turning plate 12, and the floating column 15 above which the positioning flange 14 is fixed is matched with the slide sleeve 16; the spring 17 is fixed below the floating column 15; a station of a fixture comprises the items described above, and the fixture is composed of 2 or 4 stations.

In a working process, a wheel is placed on the positioning flange 14 at one of the stations and is pressed down, the spring 17 is compressed, and when coming into contact with the positioning block 18, a lower edge of the wheel is tightly pressed and fixed with the press head 11; the servo motor 2 drives the rotating plate 6, the wheel and the like to rotate by 90 degrees or 180 degrees through the shaft 5; when the wheel is transferred to a position below the pad printing head 13, the air cylinder 9 drives the slide block 8 to move rightwards through the guide rail 7; the turning plate 12 and the wheel are rotated by a certain degree under the action of the connecting rod 10; at the moment, the pad printing head 13 moves downwards to print a fixed pattern onto a front face of the wheel.

1. A fixture for station-transferring wheel printing, which comprises two or four stations, with each station comprising a stand, a servo motor, a platform, a bearing seat, a shaft, a rotating plate, a guide rail, a slide block, an air cylinder, a connecting rod, a press head, a turning plate, a pad printing head, a positioning flange, a floating column, a slide sleeve, a spring and a positioning block; characterized in that the platform above which the bearing seat is mounted is fixed above the stand; the shaft above which the rotating plate is mounted is fixed inside the bearing seat through the bearing; an output end of the servo motor fixed below the platform is connected with the shaft; the slide block is fixed above the rotating plate through the guide rail; the turning plate above which the positioning block and the press head are fixed is hinged with the rotating plate; two ends of the connecting rod are respectively hinged with a downside of the turning plate and the slide block; an output end of the air cylinder fixed on the rotating plate is connected with the slide block; the slide sleeve is fixed above the turning plate, and the floating column above which the positioning flange is fixed is matched with the slide sleeve; and the spring is fixed below the floating column.

2. The fixture for station-transferring wheel printing according to claim 1, characterized in that the positioning flange consists of a center shaft and a positioning column, corresponding to a center hole and one of bolt holes of a wheel respectively.
